(19) United States
(12) Patent Application Publication
(10) Pub. No.: US 2011/0059395 A1
(43) Pub. Date: Mar. 10, 2011

(54) LIGHT FIXING TONER, AND ONE-COMPONENT DEVELOPER AND TWO-COMPONENT DEVELOPER CONTAINING THE LIGHT FIXING TONER

(76) Inventor: Masahiko KUBO, Osaka (JP)

(21) Appl. No.: 12/873,542

(22) Filed: Sep. 1, 2010

(30) Foreign Application Priority Data
Sep. 4, 2009 (JP) P2009-205347

(51) Int. Cl. G03G 9/08

(52) U.S. Cl. 430/111.4

(57) ABSTRACT

A light fixing toner fixed by light irradiation without containing an infrared absorber, a one-component and a two-component developer containing the light fixing toner are provided. An infrared absorber-free light fixing toner is constituted of toner base particles containing a binder resin and a colorant, and having a shape factor SF-2 of from 105 to 115, and external additives, wherein a relative refractive index n₂/n₁ is from 0.85 to 1.10.

### CROSS-REFERENCE TO RELATED APPLICATION

This application claims priority to Japanese Patent Application No. 2009-205347, which was filed on Sep. 4, 2009, the contents of which are incorporated herein by reference in its entirety.

### BACKGROUND OF THE INVENTION

1. Field of the Invention

The present invention relates to a light fixing toner, and a one-component and a two-component developer containing the light fixing toner.

2. Description of the Related Art

Electrophotography is an image forming method comprising forming an electrostatic latent image on a photosensitive drum utilizing photoconductive phenomenon, developing the electrostatic latent image with a toner to form a toner image (visible image), transferring the toner image to a recording paper, and fixing the transferred toner image to the recording paper. Various fixing apparatuses utilizing heat, pressure or light are used to fix a toner image. For example, a fixing apparatus using a heating roller is most commonly used.

However, the fixing apparatus using a heating roller has high heat efficiency, but involves loss time of several tens of seconds in the initial heating (initial rising) of the apparatus. In addition, the fixing apparatus using a heating roller has a problem to easily contaminate a recording paper by offset of a residual toner on the heating roller. Furthermore, the fixing apparatus using a heating roller nips a recording paper with a pair of rollers, and therefore has a further problem that wrinkles, break and the like due to snaking are easily to cause in a recording paper in the case that a continuous paper is used as the recording paper.

A fixing apparatus utilizing pressure has advantages such that warming up, a heat source and the like are not necessary, and is therefore noted. However, the fixing apparatus utilizing pressure has the difficulty to strongly fix a toner image to a recording paper. In addition, the fixing apparatus utilizing pressure pressurizes a recording paper by passing the recording paper between a pair of rollers, and therefore has a problem that wrinkles, break and the like due to snaking are easily to cause in the recording paper in the case that a continuous paper is used as the recording paper. Furthermore, the fixing apparatus utilizing pressure has a problem that a paste spreads out of a background by pressure in the case that a self-sticking paper for label formation widely used in recent years is used as a recording paper.

On the other hand, a fixing apparatus utilizing energy of flash light of a xenon lamp or the like is that a toner selectively absorbs light energy, and therefore a toner image can be fixed at high speed. In addition, the fixing apparatus utilizing energy of flash light can conduct fixing of a toner image to a recording paper in non-contact, and therefore has the advantages that wrinkles, break and the like due to snaking of a recording paper are free of worries, a paste does not spread out of a self-sticking paper in fixing a toner image to the self-sticking paper, and the toner image is easily fixed to the paper.

However, the fixing by flash light has a problem that a black toner can sufficiently be fixed, but fixability of a color toner is low. The black toner is possible to absorb light in the overall wavelength region, and due to this, absorbs flash light (light having peak of intensity in a range of from 800 nm to 1,000 nm) by a xenon lamp, thereby temperature is sufficiently increased. However, the color toner hardly absorbs light having a wavelength in a range of from 800 nm to 1,000 nm, and as a result, temperature is difficult to be increased.

As a toner to overcome the problem, Japanese Unexamined Patent Publication JP-A 11-38667 (1999) describes a color toner having added thereto an infrared absorber absorbing light in a near-infrared region (region having a wavelength of from 800 nm to 1,000 nm). However, the infrared absorber absorbing light in a near-infrared region also absorbs light in a visible light region (region having a wavelength of 780 nm or less). Therefore, where a large amount of the infrared absorber is added to a toner to improve light absorption efficiency of the toner, absorption amount of light in a visible light region is also increased, and this gives arise to a problem that color reproducibility of a toner image fixed (fixed image) is decreased.

To overcome the problem, Japanese Unexamined Patent Publication JP-A 2008-107576 describes an image forming apparatus comprising a flash fixing device and a laser fixing device. The image forming apparatus described in JP-A 2008-107576 performs that a toner is heated with flash light by the flash fixing device, and each color toner is irradiated with laser light having the maximum absorption wavelength of the each color toner by the laser fixing device, thereby heat-fixing the toner. According to the image forming apparatus described in JP-A 2008-107576, the amount of an infrared absorber added to a toner can be reduced, and as a result, color reproducibility of a fixed image is improved.

However, the toner described in JP-A 2008-107576 still contains an infrared absorber, resulting in decreasing color reproducibility of a fixed image. Furthermore, the image forming apparatus described in JP-A 2008-107576 requires two devices of a flash fixing device and a laser fixing device, as a fixing device. This gives rise to the problems that an apparatus constitution is complicated, and cost is increased.

### SUMMARY OF THE INVENTION

The invention has been made to overcome the above problems, and has an object to provide a light fixing toner fixed by light irradiation without containing an infrared absorber, a one-component developer containing the light fixing toner, and a two-component developer containing the light fixing toner.

The invention provides an infrared absorber-free light fixing toner for use in a fixing method of fixing a toner to a recording medium by irradiation of light having a wavelength within an absorption wavelength region of a colorant, comprising:

toner base particles comprising a binder resin and a colorant, the toner base particles having a shape factor SF-2 of from 105 to 115; and

external additives externally added to the toner base particles,

a relative refractive index n₂/n₁ as a ratio between an absolute refractive index n₁ of the external additives and an absolute refractive index n₂ of the binder resin being from 0.85 to 1.10.

According to the invention, the toner contains toner base particles comprising a binder resin and a colorant, and does not contain an infrared absorber. The toner base particles have a shape factor SF-2 of from 105 to 115. Furthermore, in the toner according to the invention, a relative refractive index n₂/n₁ as a ratio between an absolute refractive index nₗ of the external additives and an absolute refractive index n₂ of the binder resin is from 0.85 to 1.10.

When a toner surface is irradiated with light, a part of light is reflected by the toner surface, and the remainder enters inside the toner. In this case, the smaller an incident angle of the light, the amount of reflection light is decreased and the amount of incident light is increased.

The toner according to the invention is that the shape factor SF-2 of the toner base particles is from 105 to 115. Therefore, the toner surface has less irregularities. As a result, the amount of light having small incident angle to the whole amount of light entering the toner surface is increased, and the reflection amount as a whole is decreased. Due to this, the toner according to the invention can make a lot of light enter inside the toner.

The case that light enters the toner base particles includes the case that light directly enters the toner base particles without passing through external additives, and the case that light entered external additives passes through the external additives, and enters the toner base particles in the boundary between the external additives and the toner base particles. In the case that light passes through the external additives and enters the toner base particles, when the relative refractive index n₂/n₁ is from 0.85 to 1.10, reflection of light in the boundary between the external additives and the toner base particles can be suppressed, thereby increasing the amount of incident light to the toner base particles. On the other hand, where the relative refractive index n₂/n₁, is larger than 1.10, reflection of light in the boundary between the external additives and the toner base particles is increased, and in addition to this, in the case that a toner is supported on a recording medium in a layered state, light entered the toner base particles in the upper toner layer is difficult to move into the toner base particles in the lower toner layer.

As described above, the toner according to the invention increases the amount of light absorbed in a colorant. Therefore, the binder resin melts by heat due to heat-generation of a colorant having light absorbed therein, and as a result, the toner can be fixed to a recording medium. Therefore, the toner according to the invention can be used in a fixing method of fixing a toner to a recording medium by irradiation of light having an absorption wavelength region of a colorant, without containing an infrared absorber.

In the invention, it is preferable that the toner is a cyan toner, a magenta toner or a yellow toner.

According to the invention, the toner according to the invention is a cyan toner, a magenta toner or a yellow toner. Black toner is a toner absorbing light in a visible light region, thereby developing black color. Therefore, even though an infrared absorber is contained in the toner, decrease in color reproducibility is difficult to occur. However, each color toner is a toner utilized as a primary color of color mixture by absorption of light of a specific absorption wavelength region of a colorant. Therefore, where an infrared absorber is contained in the toner, the infrared absorber absorbs light of a wavelength region necessary for color reproduction, resulting in decrease in color reproducibility.

As described above, the toner according to the invention is an infrared absorber-free light fixing toner, and therefore does not induce decrease in color reproducibility due to the infrared absorber. Consequently, according to the toner of the invention, an image having good image quality can be obtained.

In the invention, it is preferable that the binder resin has an absolute refractive index n₂ of 1.5 or less.

According to the invention, the absolute refractive index n₂ of the binder resin is 1.5 or less. This makes light easily enter the toner base particles. As a result, fixability can further be improved.

The invention provides a one-component developer comprising the light fixing toner mentioned above.

According to the invention, a one-component developer comprising the light fixing toner can be realized. The one-component developer according to the invention can be used in a fixing method of fixing a toner to a recording medium by irradiation of light having a wavelength in an absorption wavelength region of a colorant.

The invention further provides a two-component developer comprising the light fixing toner mentioned above and a carrier.

According to the invention, a two-component developer comprising the light fixing toner can be realized. The two-component developer according to the invention can be used in a fixing method of fixing a toner to a recording medium by irradiation of light having a wavelength in an absorption wavelength region of a colorant.

### BRIEF DESCRIPTION OF THE DRAWINGS

Other and further objects, features, and advantages of the invention will be more explicit from the following detailed description taken with reference to the drawings wherein:

FIG. 1 is a process chart showing production steps of a toner by a melt-kneading pulverization method;

FIG. 2 is a schematic view schematically showing the constitution of the image forming apparatus;

FIG. 3 is the schematic view schematically showing the constitution of the developing device; and

FIG. 4 is the schematic view schematically showing the constitution of the fixing part.

### DETAILED DESCRIPTION

Now referring to the drawings, preferred embodiments of the invention are described below.

1. Toner

(1) Toner

The toner according to the invention is a light fixing toner, and fixes to a recording medium without containing an infrared absorber by irradiation of light having a wavelength in an absorption wavelength region of a colorant. The toner according to the invention comprises toner base particles and external additives. The toner base particles have a shape factor SF-2 of from 105 to 115, and comprise a binder resin and a colorant. The term “infrared absorber” used herein means an infrared absorber used in the conventional light fixing toner, and examples of the infrared absorber include cyanine compounds, polymethine compounds, aluminium compounds, diimonium compounds, phthalocyanine compounds, merocyanine compounds, benzene-thiol metal complexes, mercaptophenol metal complexes, aromatic diamine metal complexes, nickel complex compounds, anthraquinone compounds, naphthalocyanine compounds and indolenine compounds. The shape factor SF-2 of the toner base particles can be measured as follows.

Shape factor SF-2 of toner base particles

Metal film (Au film, film thickness: 0.5 μm) is formed on surfaces of the toner base particles by sputter deposition to form metal-coated particles. Using a scanning electron microscope (trade name: S-570, manufactured by Hitachi, Ltd.), 200 to 300 metal-coated particles are randomly extracted from the metal-coated particles obtained above under the conditions of an accelerating voltage of 5 kV and 1,000-fold magnification, and a photo shoot is conducted. The pieces of photograph data obtained are image-analyzed with an image analyzing software (trade name: A-ZO KUN, manufactured by Asahi Kasei Engineering Corporation). Particle analyzing parameters of the image analyzing software (A-ZO KUN) are as follows.

Small graphic removal area: 100 pixels

Contraction separation: Number of times 1

Small graphic: 1

Number of times: 10

Noise removal filer: None

Shading: None

Expression unit of result: μm

Values calculated and obtained from the following expressions (A) and (B) using a maximum length (absolute maximum length) MXLNG, a peripheral length PERI and an graphic area (projected area) AREA of the particles obtained by image analysis are used as a shape factor SF-1 and a shape factor SF-2 of a toner.

Shape factor SF-1={(MXLNG)²/AREA}×25×π (A)

Shape factor SF-2={(PERI)²/AREA}×(25/π) (B)

wherein π represents a circular constant.

The shape factor SF-1 is a value represented by the above expression (A), and indicates sphericity (degree of roundness) of a shape of a particle. When the value of the shape factor SF-1 is 100, the shape of a particle is a true sphere. The shape becomes amorphous with increasing the value of the shape factor SF-1. The shape factor SF-2 is a value represented by the above expression (B), and indicates degree of irregularity of surface shape of a particle. When the shape of a particle is a true sphere, the shape factor SF-2 is 100.

When a toner surface is irradiated with light, a part of light is reflected by the toner surface, and the remainder enters inside the toner. In this case, the smaller the incident angle of light, the amount of reflected light is decreased and the amount of incident light is increased. The toner according to the invention has the shape factor SF-2 of from 105 to 115. Therefore, the toner surface has less irregularities. As a result, the amount of light having a small incident angle to the whole amount of light entering the toner surface is increased, and the reflection amount as a whole is decreased. Due to this, the toner according to the invention can make a lot of light enter inside the toner.

In the toner according to the invention, a relative refractive index n₂/n₁ as a ratio between an absolute refractive index n₁ of the external additives and an absolute refractive index n₂ of the binder resin is from 0.85 to 1.10.

The case that light enters the toner base particles includes the case that light directly enters the toner base particles without passing through external additives, and the case that light entered external additives passes through the external additives, and enters the toner base particles in the boundary between the external additives and the toner base particles. In the case that light passes through the external additives and enters the toner base particles, when the relative refractive index n₂/n₁ is from 0.85 to 1.10, reflection of light in the boundary between the external additives and the toner base particles can be suppressed, thereby increasing the amount of incident light to the toner base particles. On the other hand, where the relative refractive index n₂/n₁ is larger than 1.10, reflection of light in the boundary between the external additives and the toner base particles is increased, and in addition to this, in the case that a toner is supported on a recording medium in a layered state, light entered the toner base particles in the upper toner layer is difficult to move into the toner base particles of the lower toner layer.

As described above, the toner according to the invention increases the amount of light absorbed in a colorant. Therefore, the binder resin melts by heat due to heat-generation of a colorant having light absorbed therein, and as a result, the toner can be fixed to a recording medium. Therefore, the toner according to the invention can be used in a fixing method of fixing a toner to a recording medium by irradiation of light having a wavelength in an absorption wavelength region of a colorant, without containing an infrared absorber.

The toner according to the invention is preferably a color toner such as a cyan toner, a magenta toner or a yellow toner. Black toner is a toner absorbing light in a visible light region, thereby developing black color. Therefore, even though an infrared absorber is contained in the toner, decrease in color reproducibility is difficult to occur. However, each color toner is a toner utilized as a primary color of color mixture by absorption of light in a specific absorption wavelength region of a colorant. Therefore, where an infrared absorber is contained in the toner, the infrared absorber absorbs light of a wavelength region necessary for color reproduction, resulting in decrease in color reproducibility.

As described above, the toner according to the invention is an infrared absorber-free light fixing toner, and therefore does not induce decrease in color reproducibility due to the infrared absorber. Consequently, according to the toner of the invention, an image having good image quality can be obtained.

The toner according to the invention can be produced by the following toner production method from the following toner raw materials.

(2) Toner Raw Materials

Toner raw materials comprise a binder resin, a colorant, external additives, and other additives.

(2-1) Binder Resin

The binder resin is not particularly limited, and the binder resin for black toner or color toner may be used. Examples of the binder resin include: polyester resin; styrene resin such as polystyrene and styrene-acrylic ester copolymer resin; acrylic resin such as polymethylmethacrylate (PMMA); polyolefin resin such as polyethylene; polyurethane resin; epoxy resin; and silicone resin.

The absolute refractive index n₂ of the binder resin is preferably 1.5 or less. In the toner according to the invention, when the absolute refractive index n₂ of the binder resin is 1.5 or less, light can easily enter the toner base particles, and fixability of the toner can further be improved.

The absolute refractive index n₂ of the binder resin is, for example, that a polyester resin is 1.57, a styrene-acrylic resin is 1.56, PMMA is 1.49, and a silicon resin is 1.41. The binder resin is preferably PMMA or a silicon resin.

The binder resin may contain fluorine to decrease the absolute refractive index n₂. For example, as a fluorine-containing component in the case of decreasing the absolute refractive index n₂ of the polyester resin, an ethylene oxide adduct of 2,2-bis(4-hydroxyphenyl)hexafluoropropane and the like can be utilized in a diol component.

The “absolute refractive index n₂ of the binder resin” can be measured by the conventional prism coupling method. Specifically, the absolute refractive index n₂ is measured at a measurement temperature of 20° C. using Abbe refractomer NAR-1T SOLID (manufactured by Atago Co., Ltd.) and using a light source lamp: D ray (589 nm).

(2-2) Colorant

Colorant includes dyes and pigments. Among them, pigments are preferably used. Pigments have excellent light resistance and color forming property as compared with dyes. Therefore, a toner having excellent light resistance and color forming property can be obtained by using pigments.

Examples of the colorant include yellow toner colorant, magenta toner colorant, cyan toner colorant, and black toner colorant.

Examples of the yellow toner colorant include organic pigments such as C.I. Pigment Yellow 1, C.I. Pigment Yellow 5, C.I. Pigment Yellow 12, C.I. Pigment Yellow 15, C.I. Pigment Yellow 17, C.I. Pigment Yellow 74, C.I. Pigment Yellow 93, C.I. Pigment Yellow 180 and C.I. Pigment Yellow 185; inorganic pigments such as yellow iron oxide and yellow ocher; nitro dyes such as C.I. Acid Yellow 1; and oil-soluble dyes such as C.I. Solvent Yellow 2, C.I. Solvent Yellow 6, C.I. Solvent Yellow 14, C.I. Solvent Yellow 15, C.I. Solvent Yellow 19 and C.I. Solvent Yellow 21, that are classified by a color index.

Examples of the magenta toner colorant include C.I. Pigment Red 49, C.I. Pigment Red 57, C.I. Pigment Red 81, C.I. Pigment Red 122, C.I. Solvent Red 19, C.I. Solvent Red 49, C.I. Solvent Red 52, C.I. Basic Red 10 and C.I. Disperse Red 15, that are classified by a color index.

Examples of the cyan toner colorant include C.I. Pigment Blue 15, C.I. Pigment Blue 16, C.I. Solvent Blue 55, C.I. Solvent Blue 70, C.I. Direct Blue 25, and C.I. Direct Blue 86.

Examples of the black toner colorant include carbon black such as channel black, roller black, disk black, gas furnace black, oil furnace black, thermal black, and acetylene black.

In addition to the above-described colorants, bright red pigments, green pigments and the like can be used. The colorants may be used each alone, or two or more having different colors may be used in combination. Furthermore, plural colorants of the same color series can be used.

The colorant is preferably used as a masterbatch. The masterbatch of a colorant can be produced by, for example, kneading a melt of a binder resin and a colorant. The binder resin used in the masterbatch is the same kind of a resin as the binder resin of a toner, or a resin having good compatibility with the binder resin of a toner. Proportions used of the binder resin and the colorant in the masterbatch are not particularly limited, but the colorant is preferably used in a range of from 30 parts by weight to 100 parts by weight based on 100 parts by weight of the binder resin. Particle size of the masterbatch is not particularly limited. However, preferably the masterbatch is granulated into, for example, particles having a particle size of from about 2 mm to 3 mm, and such particles are used.

Content of the colorant in a toner is not particularly limited. However, the colorant is preferably used in a range of from 4 parts by weight to 20 parts by weight based on 100 parts by weight of the binder resin. Use of the colorant in this range can suppress filler effect due to addition of the colorant and can obtain a toner having high coloring power. On the other hand, where the content of the colorant in a toner exceeds 20 parts by weight, fixability of a toner may be decreased due to the filler effect.

(2-3) External Additives

Inorganic fine particles can preferably be used as the external additives for the purpose of improving fluidity and chargeability. The external additives have a primary particle size of preferably from 5 nm to 2 μm, and particularly preferably from 5 nm to 500 nm. The external additives preferably have a specific surface area by BET method of from 20 m²/g to 500 m²/g.

Examples of the inorganic fine particles include silica, titanium oxide, alumina, barium titanate, magnesium titanate, calcium titanate, strontium titanate, zinc oxide, tin oxide, silica sand, clay, mica, wollastonite, diatomaceous earth, chromium oxide, cerium oxide, colcothar, antimony trioxide, magnesium oxide, zirconium oxide, barium sulfate, barium carbonate, calcium carbonate, silicon carbide and silicon nitride.

The external additives are preferably surface-treated with a surface-treating agent. The surface-treated external additives increase hydrophobicity, and therefore can prevent deterioration of fluidity and chargeability under high humidity. Examples of the preferred surface-treating agent include a silane coupling agent, a silylating agent, a silane coupling agent having an alkyl fluoride group, an organic titanate silane coupling agent, an aluminum silane coupling agent, a silicone oil and a modified silicone oil.

The external additives are selected depending on the binder resin such that the relative refractive index n₂/n₁ as a ratio between an absolute refractive index n₂ of the binder resin and an absolute refractive index n₁ of the external additives is from 0.85 to 1.10. The absolute refractive index n₁ of the external additives is, for example, that barium carbonate is 1.62, silica is 1.45, alumina is 1.76, silica sand is 1.53, zinc oxide is 1.92 and titanium oxide is 2.52. The “absolute refractive index n₁ of the external additives” can be measured by the conventional prism coupling method. Specifically, the absolute refractive index n₁ is measured at a measurement temperature of 20° C. using Abbe refractomer WAR-1T SOLID (manufactured by Atago Co., Ltd.) and using a light source lamp: D ray (589 nm).

Combination of the binder resin and the external additives is preferably that the binder resin is polymethyl methacrylate (PMMA) and the external additives are barium carbonate or silica sand. In the toner according to the invention, when the binder resin is polymethyl methacrylate and the external additives are barium oxide or silica sand, fixability of the toner can further be improved.

(2-4) Other Additives

As necessary, the toner may contain a wax, a charge control agent and the like in addition to the binder resin and the colorant.

(2-4-1) Wax

When a toner contains a wax, the toner gets soft as compared with a toner that does not contain a wax. Therefore, when a toner contains a wax, a toner image fixed to a recording medium is difficult to cause cracks, peeling and the like. In addition, when a toner contains a wax, image quality such as luster can be improved.

The wax used is not particularly limited, and can use materials conventionally used in this field. Examples of the wax that can be used include petroleum waxes such as paraffin wax and its derivative, and microcrystalline wax and its derivative; hydrocarbon synthetic waxes such as Fischer-Tropsch wax and its derivative, polyolefin wax and its derivative, low molecular polypropylene wax and its derivative, and polyolefin polymer wax and its derivative; carnauba wax and its derivative; and ester waxes. The waxes may be used each alone, or two or more of them may be used in combination.

The amount of the wax used is not particularly limited, and can appropriately be selected from a wide range. The amount of the wax used is preferably in a range of from 0.2 part by weight to 20 parts by weight based on 100 parts by weight of the binder resin. Where the amount of the wax used is larger than 20 parts by weight based on 100 parts by weight of the binder resin, filming on a photoreceptor, spent to a carrier, and the like may occur. On the other hand, where the amount of the wax used is less than 0.2 part by weight based on 100 parts by weight of the binder resin, the effect by the wax may not sufficiently be exhibited.

Melting point of the wax is not particularly limited. Where the melting point of the wax is too high, the effect of the wax cannot be obtained. On the other hand, where the melting point of the wax is too low, storage stability of the toner is deteriorated. For those reasons, the melting point of the wax is preferably in a range of from 30° C. to 120° C.

The “melting point of the wax” can be obtained as a temperature of the top of an endothermic peak corresponding to melting of a DSC curve using a differential scanning calorimeter (trade name: DSC220, manufactured by Seiko Instruments & Electronics, Ltd.) Specifically, 1 g of a wax sample is heated to increase its temperature from 20° C. to 200° C. in a temperature rising rate of 10° C. per minute, operation of rapidly cooling the sample from 200° C. to 20° C. is repeated two times, and a DSC curve is measured. A temperature of the top of an endothermic peak corresponding to melting in the DSC curve measured by the second operation can be obtained as a “melting point of a wax”.

(2-4-2) Charge Control Agent

The charge control agent is added to impart preferred chargeability to a toner. The charge control agent is not particularly limited, and can use the conventional charge control agents for controlling positive charge and for controlling negative charge.

Examples of the charge control agent for controlling positive charge include basic dyes, quaternary ammonium salts, quaternary phosphonium salts, aminopyrine, pyrimidine compounds, multinuclear polyamino compounds, aminosilane, nigrosine dyes and its derivative, triphenylmethane derivatives, guanidine salts and amidine salts.

Examples of the charge control agent for controlling negative charge include oil-soluble dyes such as oil black and spirone black; metal-containing azo compounds, azo complex dyes, naphthenic acid metal salts, salicylic acid and metal complexes and metal salts of its derivative (metal is chromium, zinc, zirconium and the like), boron compounds, fatty acid soaps, long-chain alkyl carboxylic acid salts, and resin acid soaps.

The charge control agents for controlling positive charge may be used each alone, or two or more of them may be used in combination. Similarly, the charge control agents for controlling negative charge may be used each alone, or two or more of them may be used in combination. When the binder resin and an incompatible charge control agent are used, the incompatible charge control agent is used in a range of preferably from 0.5 part by weight to 5 parts by weight, and more preferably from 0.5 part by weight to 3 parts by weight, based on 100 parts by weight of the binder resin. Where the incompatible charge control agent is contained in an amount larger than 5 parts by weight based on 100 parts by weight of the binder resin, a carrier is contaminated, and toner scattering is generated. Where the content of the incompatible charge control agent is less than 0.5 part by weight, sufficient chargeability cannot be imparted to a toner.

(3) Toner Production Method

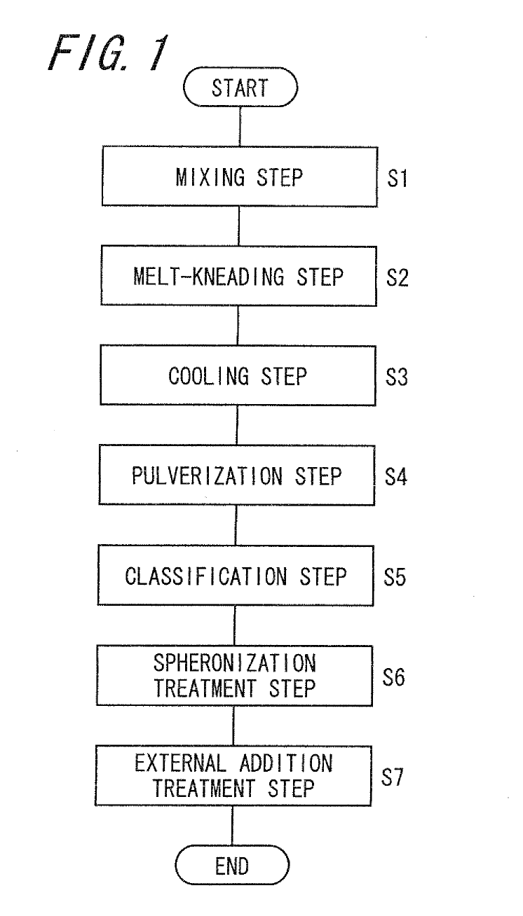

Toner production method is not particularly limited, and can use a dry process and a wet process. Production of a toner by a melt-kneading pulverization method that is one of a dry process is described below. FIG. 1 is a process chart showing production steps of a toner by a melt-kneading pulverization method. Production steps of a toner by a melt-kneading pulverization method comprise a mixing step S1, a melt-kneading step S2, a cooling step S3, a pulverization step S4, a classification step S5, a spheronization treatment step S6 and an external addition treatment step S7.

(3-1) Mixing Step S1

In the mixing step S1, a binder resin, a colorant and additives such as a wax and a charge control agent are dry mixed. Mixing machine used for dry mixing is not particularly limited, and can use the conventional mixing machines. Examples of the mixing machine that can be used include Henschel type mixing apparatuses such as HENSCHEL MIXER (trade name, manufactured by Mitsui Mining Co., Ltd.), SUPERMIXER (trade name, manufactured by Kawata Mfg Co., Ltd), and MECHANOMILL (trade name, manufactured by Okada Seiko Co., Ltd.); ANGMILL (trade name, manufactured by Hosokawa Micron Corporation); HYBRIDIZATION SYSTEM (trade name, manufactured by Nara Machinery Co., Ltd.); and COSMOSYSTEM (trade name, manufactured by Kawasaki Heavy Industries, Ltd.)

(3-2) Melt-Kneading Step S2

In the melt-kneading step S2, a mixture obtained in the mixing step S1 is melt-kneaded. In the melt-kneading step S2, the mixture is stirred and kneaded while heating to a temperature higher than the melting temperature of a binder resin. The “temperature higher than the melting temperature of a binder resin” used herein, is from about 80° C. to 200° C., and preferably from about 100° C. to 150° C. A kneading machine used for melt-kneading is not particularly limited, and can use ordinary kneading machines such as a twin-screw extruder, a three-roll mill and a laboplast mill. Specific examples of the kneading machine include single-screw or twin-screw extruders such as TEM-100B (trade name, manufactured by Toshiba Machine Co., Ltd.) and PCM-65/87 (trade name, manufactured by Ikegai); and open roll systems such as KNEADEX (trade name, manufactured by Mitsui Mining Co., Ltd.). (3-3) Cooling Step S3

In the cooling step S3, a melt-kneaded material obtained in the melt-kneading step S2 is cooled and solidified.

(3-4) Pulverization Step S4

In the pulverization step S4, a solidified material obtained in the cooling step S3 is pulverized. The solidified material is pulverized using a cutter mill, a feather mill, a jet mill or the like. Those pulverizers may be used each alone, or two or more of them may be used in combination. For example, when a solidified material is roughly pulverized with a cutter mill and then finely pulverized with a jet mill, colored resin particles having a desired particle size are obtained.

(3-5) Classification Step S5

In the classification step S5, colored resin particles having a particle size other than the desired particle size are removed from the colored resin particles obtained in the pulverization step S4. In the classification step S5, excessively-pulverized resin particles are removed from a coarse powder obtained in the pulverization step S4 using a classifier. The classifier can use, for example, a rotary classifier such as TSP separator (trade name, manufactured by Hosokawa Micron Corporation).

(3-6) Spheronization Treatment Step S6

In the spheronization treatment step S6, colored resin particles classified in the classification step S5 are spheronized, thereby preparing toner base particles having a shape factor SF-2 adjusted to from 105 to 115. The spheronization treatment step S6 can use an impact spheronization apparatus or a hot air spheronization apparatus. Examples of the impact spheronization apparatus that can be used include FACULTY (trade name, manufactured by Hosokawa Micron Corporation) and HYBRIDIZATION SYSTEM (trade name, manufactured by Nara Machinery Co., Ltd.) Examples of the hot air spheronization apparatus that can be used includes a surface reforming machine, METEORAINBOW (trade name, manufactured by Nippon Pneumatic Mfg Co., Ltd.). The colored resin particles formed in the melt-kneading pulverization step are generally amorphous before the spheronization treatment. Shape factor SF-1 frequently exceeds 150, and shape factor SF-2 frequently exceeds 140.

(3-7) External Addition Treatment Step S7

In the external addition treatment step S7, external additives are adhered to toner base particles obtained in the spheronization treatment step S6. The external addition treatment step S7 can use an impact pulverizer or various mixing machines. Examples of the mixing machine that can be used include MECHANOFUSION SYSTEM (trade name, manufactured by Hosokawa Micron Corporation), CYCLOMIX (trade name, manufactured by Hosokawa Micron Corporation), NANOACTIVATOR (trade name, manufactured by Hosokawa Micron Corporation), HENSCHEL MIXER (trade name, manufactured by Mitsui Mining Co., Ltd.) and MECHANOMILL (trade mane, manufactured by Okada Seiko Co., Ltd.).

2. Developer

The developer according to the invention contains the toner according to the invention. The toner according to the invention can be used in a one-component developer and can be used in a two-component. developer.

(1) One-Component Developer

The one-component developer does not contain a carrier and consists of the toner according to the invention. The one-component developer is conveyed by a development sleeve, frictionally charged with a blade or a fur brush, and then fed to an electrostatic latent image by electrostatic power, thereby developing the electrostatic latent image. The one-component developer according to the invention can be used in a fixing method of fixing a toner to a recording medium by irradiation of light having a wavelength in an absorption wavelength region of a colorant.

(2) Two-Component Developer

The two-component developer contains the conventional carrier together with the toner according to the invention. The two-component developer according to the invention can be used in a fixing method of fixing a toner to a recording medium by irradiation of light having a wavelength in an absorption wavelength region of a colorant.

Examples of the carrier that can be used include single or composite ferrite carriers comprising iron, copper, zinc, nickel, cobalt, manganese, chromium and the like; resin-coated carriers comprising carrier core particles comprising ferrite, and a coating material covering the surface of the carrier core particles; and resin-dispersed carriers comprising a resin and particles having magnetic property dispersed therein.

The coating material is not particularly limited, and can use the conventional coating materials. Examples of the coating material that can be used include polytetrafluoroethylene, monochlorotrifluoroethylene polymer, polyvinylidene fluoride, silicon resins, polyester resins, metal compounds of di-tert-butylsalicylic acid, styrenic resins, acrylic resins, polyacid, polyvinylal, nigrosine, aminoacrylate resins, basic dyes, lake products of basic dyes, silica fine powder and alumina fine powder. The coating materials are appropriately selected depending on a toner component, and may be used each alone, or two or more of them may be used in combination.

The resin used in a resin-dispersed carrier is not particularly limited, and examples of the resin that can be used include styrene-acryl resins, polyester resins, fluorine resins and phenolic resins. The resins used in a resin-dispersed carrier are appropriately selected depending on a toner component, and may be used each alone, or two or more of them may be used in combination.

A shape of the carrier is preferably a spherical shape or a flat shape. A particle size of the carrier is not particularly limited. However, considering high quality of a fixed image, the particle size is preferably in a range of from 10 μm to 100 μm, and more preferably a range of from 20 μm to 50 μm.

Resistivity of the carrier is preferably 10⁸ Ω·cm or more, and more preferably 10¹² Ω·cm or more. Where the resistivity of the carrier is low, charges are injected in the carrier in applying bias voltage, and carrier particles may be adhered to a photoreceptor drum. Furthermore, where the resistivity of the carrier is low, breakdown of bias voltage is liable to occur. The “resistivity of the carrier” used herein means current value when a carrier is placed in a vessel having a sectional area of 0.50 cm² and having an electrode on the bottom, followed by tapping, a load of 1 kg/cm² is applied to the carrier particles filled in the vessel by the weight, and voltage generating electric field of 1,000 V/cm² between the weight and the bottom electrode is applied.

Magnetization intensity (maximum magnetization) of the carrier is preferably in a range of from 10 emu/g to 60 emu/g, and more preferably a range of from 15 emu/g to 40 emu/g. Although depending on flux density of a development roller, when magnetization intensity of the carrier is less than 10 emu/g under the ordinary flux density conditions, magnetic constraint force does not work, resulting in carrier scatter. Where the magnetization intensity of the carrier exceeds 60 emu/g, chain of the carrier is too high. Where chain of the carrier is too high in non-contact development, a photoreceptor drum and a carrier are difficult to maintain a non-contact state. Where chain of the carrier is too high in contact development, sweep streaks are easily generated in a toner image.

Proportions used of the toner and the carrier in the two-component developer are not particularly limited, and can appropriately be selected depending on the kind of the toner and the carrier. For example, in the case of using a resin-coated carrier (density: 5 g/cm² to 8 g/cm²), the toner is used such that the toner is contained in the developer in an amount of from 2% by weight to 30% by weight, and preferably from 2% by weight to 20% by weight, based on the weight of the whole amount of the developer. In the two-component developer, the coverage of the carrier by the toner is preferably in a range of from 40% to 80%.

3. Image Forming Apparatus

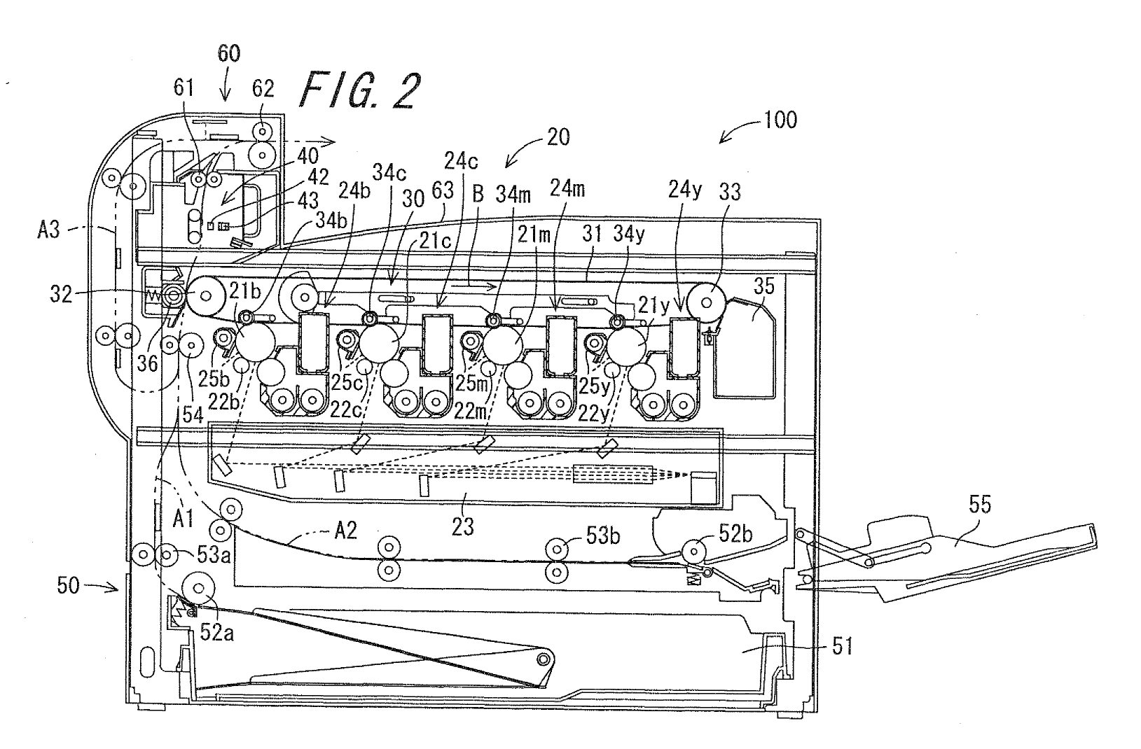

The developer according to the invention can be used in a laser fixing image forming apparatus 100 shown in FIG. 2. FIG. 2 is a schematic view schematically showing the constitution of the image forming apparatus 100. The image forming apparatus 100 is a multifunctional peripheral having copying function, printer function and facsimile function in combination, and forms full color or monochrome image on a recording medium according to image information transmitted. The image forming apparatus 100 has three kinds of printing modes of copier mode (copying mode), printer mode and facsimile mode. A printing mode is selected by a control unit section (not shown) according to operation input from an operation part (not shown) and reception of printing job from personal computers, mobile terminal equipments, information recording storage media, external instruments using memories, and the like.

The image forming apparatus 100 comprises a toner image forming section 20, a transfer section 30, a fixing section 40, a recording medium feed section 50, a discharging section 60, and a control unit section (not shown). The toner image forming section 20 comprises photoreceptor drums 21b, 21c, 21m and 21y, charging parts 22b, 22c, 22m and 22y, an exposure unit 23, developing devices 24b, 24c, 24m and 24y, and cleaning units 25b, 25c, 25m and 25y. The transfer section 30 comprises an intermediate transfer belt 31, a driving roller 32, a driven roller 33, intermediate transfer rollers 34b, 34c, 34m and 34y, a transfer belt cleaning unit 35 and a transfer roller 36.

Four members are provided for the photoreceptor drum 21, the charging part 22, the developing device 24, the cleaning unit 25 and the intermediate transfer roller 34 in order to respond to image information of each color of black (k), cyan (c), magenta (m) and yellow (y) contained in color image information. In the present description, in the case of distinguishing each member (every four members are provided according to each color), an alphabet showing each color is added to the end of the numeral showing each member to constitute a reference mark. In the case of generic name of each member, only numeral showing each member is shown to constitute a reference mark.

The photoreceptor drum 21 is rotation-drivably supported around an axis line by a driving part (not shown), and comprises a conductive substrate and a photosensitive layer formed on the surface of the conductive substrate, which are not shown. The conductive substrate can have various shapes, and examples of the shape include a cylindrical shape, a columnar shape and a thin film sheet shape. The photosensitive layer is formed by, for example, laminating a charge generating layer containing a charge generating substance and a charge transporting layer containing a charge transporting substance.

The charging part 22, the developing device 24 and the cleaning unit 25 are arranged in this order around the photoreceptor drum 21 in its rotation direction. The charging part 22 is arranged in downward in vertical direction than the developing device 24 and the cleaning unit 25.

The charging part 22 is a member charging the surface of the photoreceptor drum 21 to given polarity and potential. The charging part 22 is arranged at a position facing the photoreceptor drum 21 along the longitudinal direction of the photoreceptor drum 21. In the case of a contact-charging type charging apparatus, the charging part 22 is arranged so as to contact with the surface of the photoreceptor drum 21. In the case of a non-contact-charging type charging apparatus, the charging part 22 is arranged so as to isolate from the surface of the photoreceptor drum 21.

The charging part 22 is arranged on the periphery of the photoreceptor drum 21 together with the developing device 24, the cleaning unit 25 and the like. The charging part 22 is preferably arranged at a position near the photoreceptor drum 21, than the developing device 24, the cleaning unit 25 and the like. This constitution can surely prevent occurrence of charging defect of the photoreceptor drum 21.

The charging part 21 can use a brush type charging device, a roller type charging device, a corona discharge device, an ion generating device, and the like. The brush type charging device and the roller type charging device are a contact-charging type charging device. The brush type charging device includes a device using charging brush and a device using magnetic brush. The corona discharge device and the ion generating device are a non-contact-charging type charging device. The corona discharge device includes a device using a wire-like discharge electrode, a device using a pin-array discharge electrode and a device using a needle-like discharge electrode.

The exposure unit 23 is arranged such that light emitted from the exposure unit 23 passes between the charging part 22 and the developing device 24, and illuminates the surface of the photoreceptor drum 21. The exposure unit 23 forms an electrostatic latent image corresponding to image information of each color on the respective surfaces of the photoreceptor drums 21b, 21c, 21m and 21y by irradiating the surfaces of the photoreceptor drums 21b, 21c, 21m and 21y in charged state with laser light corresponding to image information of each color, respectively. The exposure unit 23 can use, for example, a laser scanning unit (LSU) equipped with a laser irradiation part and plural reflective mirrors. The exposure unit 23 may use, for example, a unit comprising an appropriate combination of LED (Light Emitting Diode) array, a liquid crystal shutter and a light source.

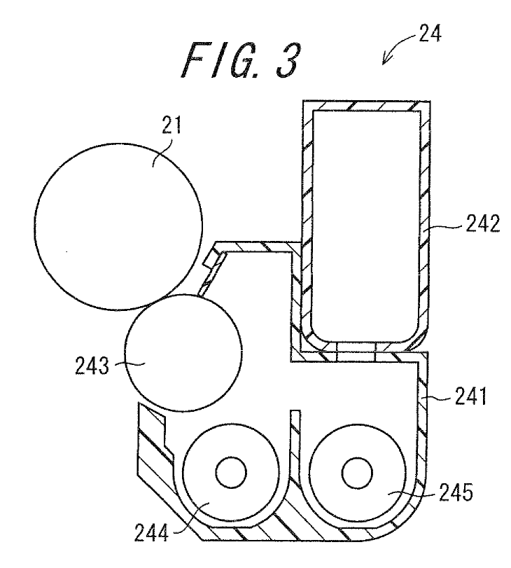

FIG. 3 is a schematic view schematically showing the constitution of the developing device 24. The developing device 24 comprises a developing tank 241 and a toner hopper 242. The developing tank 241 has the developer according to the invention in its inner space. Roller-like or screw-like members such as a developing roller 243, a feed roller 244 and a stirring roller 245 are rotatably supported in the developing tank 241. Opening is formed on the side facing the photoreceptor drum 21 of the developing tank 241, and the developing roller 243 is provided at a position facing the photoreceptor drum 21 through the opening.

The developing roller 243 is a member feeding a toner to an electrostatic latent image on the surface of the photoreceptor drum 21 at a pressure-contact part or the closest part to the photoreceptor drum 21. In feeding a toner, potential having polarity reverse to charged potential of the toner is applied as a developing bias voltage to the surface of the developing roller 243. This facilitates feeding of the toner on the surface of the developing roller 243 to the electrostatic latent image. Changing the value of the developing bias voltage can control the amount of a toner (toner attachment amount) fed to the electrostatic latent image.

The feed roller 244 is a member facing the developing roller 243 and feeding a toner to the periphery of the developing roller 243. Stirring roller 245 is a member facing the feed roller 244 and feeding a toner freshly fed to the developing tank 241 from the toner hopper 242 to the periphery of the feed roller 244. The toner hopper 242 is provided such that a toner supply port (not shown) provided downward in its vertical direction connects to a toner reception port (not shown) provided upward in a vertical direction of the developing tank 241, and supplies a toner depending on a consumption state of a toner in the developing tank 241. Other embodiment may have the constitution that the toner hopper 242 is not used, and a toner is directly supplied from a toner cartridge of each color.

The cleaning unit 25 is a member removing a toner remaining on the surface of the photoreceptor drum 21 and cleaning the surface of the photoreceptor drum 21, after transferring a toner image to the intermediate transfer belt 31 from the photoreceptor drum 21. The cleaning unit 25 uses, for example, a plate-like member such as a cleaning blade. The image forming apparatus 100 mainly uses an organic photoreceptor drum as the photoreceptor drum 21. The surface of the organic photoreceptor drum mainly comprises a resin component. Therefore, deterioration of the surface is liable to proceed by chemical action of ozone generated in charging. However, the deteriorated surface part abrades away by receiving friction action by the cleaning unit 25, and is surely removed although gradually. As a result, the deterioration problem of the surface of the photoreceptor drum 21 by ozone and the like is virtually overcome, and charged potential by charging action can stably be maintained over a long period of time. In the present embodiment, the cleaning unit 25 is provided, but the cleaning unit 25 may not be provided.

According to the toner image forming section 20, the surface of the photoreceptor drum 21 in uniformly charged state by the charging part 22 is irradiated with laser light according to image information from the exposure unit 23, and an electrostatic latent image is formed. A toner is fed to the electrostatic latent image from the developing device 24 to form a toner image, and the toner image is transferred to the intermediate transfer belt 31. After the toner image is transferred to the intermediate transfer belt 31, the toner remaining on the surface of the photoreceptor drum 21 is removed by the cleaning unit 25. A series of such a toner image forming operation is repeatedly performed.

The intermediate transfer belt 31 is an endless belt-like member provided upward in a vertical direction of the photoreceptor drum 21. The intermediate transfer belt 31 forms a loop-like passage by laying under tension with the driving roller 32 and the driven roller 33, and rotation-drives in a direction of arrow B.

The driving roller 32 is provided so as to rotation-drive around its axis line with a driving part (not shown). The driving roller 32 rotates the intermediate transfer belt 31 in the arrow B direction by the rotation driving. The driven roller 33 is provided so as to rotation-drive according to the rotation driving of the driving roller 32, and generates constant tension in the intermediate transfer belt 31 such that the intermediate transfer belt 31 does not go slack.

The intermediate transfer roller 34 is provided so as to be in pressure-contact with the photoreceptor drum 21 with the intermediate transfer belt 31 interposed therebetween and rotate around its axis line by a driving part (not shown). The intermediate transfer roller 34 has the function that a power source (not shown) for applying transfer bias voltage is connected thereto, thereby transferring a toner image on the surface of the photoreceptor drum 21 to the intermediate transfer belt 31.

The transfer roller 36 is provided so as to be in pressure-contact with the driving roller 32 with the intermediate transfer belt 31 interposed therebetween and rotate around its axis line by a driving part (not shown). In the pressure-contact part (transfer nip region) between the transfer roller 36 and the driving roller 32, a toner image borne on and conveyed by the intermediate transfer belt 31 is transferred to a recording medium delivered from a recording medium feeding section 50 described hereinafter.

The transfer belt cleaning unit 35 is provided so as to face the driven roller 33 with the intermediate transfer belt 31 interposed therebetween and be in contact with toner image-bearing face of the intermediate transfer belt 31. Where a toner remains on the intermediate transfer belt 31 with adhering thereto after transferring the toner image to the recording medium, the residual toner may adhere to the transfer roller 36 by the rotation driving of the intermediate transfer belt 31. The toner adhered to the transfer roller 36 causes contamination of the back of a recording medium subsequently transferred. Therefore, the transfer belt cleaning unit 35 is provided to remove and recover a toner on the surface of the intermediate transfer belt 31 after transferring a toner image to the recording medium.

According to the transfer section 30, in rotation-driving while the intermediate transfer belt 31 comes in contact with the photoreceptor drum 21, transfer bias voltage having polarity reverse to charged polarity of a toner on the surface of the photoreceptor drum 21 is applied to the intermediate transfer roller 34, and a toner image formed on the surface of the photoreceptor drum 21 is transferred to the intermediate transfer belt 31. In the case of a full color image, toner images of each color formed on the photoreceptor drum 21y, the photoreceptor drum 21m, the photoreceptor drum 21c and the photoreceptor drum 21b, respectively are sequentially transferred to and overlaid on the intermediate transfer belt 31 in this order, thereby a full color toner image is formed. The toner image transferred to the intermediate transfer belt 31 is conveyed to a transfer nip region by rotation driving of the intermediate transfer belt 31, and transferred to a recording medium in the transfer nip region. The recording medium having the toner image transferred thereto is conveyed to the fixing section 40.

The recording medium feeding section 50 comprises an automatic paper feed part 51, pickup rollers 52a and 52b, conveying rollers 53a and 53b, registration rollers 54, and a manual paper feed tray 55. The automatic paper feed part 51 is a container-like member provided downward in a vertical direction of the image forming apparatus 100 and storing a recording medium inside the image forming apparatus 100. The manual paper feed tray 55 is a tray-like member storing a recording medium outside the image forming apparatus 100. Examples of the recording medium include plain papers, color copy papers, overhead projector sheets and postcards.

The pickup roller 52a is a roller-like member picking up a recording medium stored in the automatic paper feed part 51 sheet by sheet and sending the recording medium to a paper conveyance path A1. The conveying rollers 53a are a pair of roller-like members provided so as to come in pressure-contact with each other, and convey a recording medium toward the registration rollers 54 in the paper conveyance path A1. The pickup roller 52b is a roller-like member picking up a recording medium stored in the manual paper feed tray 55 sheet by sheet and conveying the recording medium to a paper conveyance path A2. The conveying rollers 53b are a pair of roller-like members provided so as to come in pressure-contact with each other, and convey a recording medium toward the registration rollers 54 in the paper conveyance path A2.

The registration rollers 54 are a pair of roller-like members provided so as to come in pressure-contact with each other, and send a recording medium sent from the conveying rollers 53a and 53b to the transfer nip region in synchronization with conveying a toner image borne on the intermediate transfer belt 31 to the transfer nip region.

According to the recording medium feeding section 50, a recording medium is sent to the transfer nip region from the automatic paper feed part 51 or the manual paper feed tray 55 in synchronization with conveying a toner image borne on the intermediate transfer belt 31 to the transfer nip region, and a toner image is transferred to the recording medium.

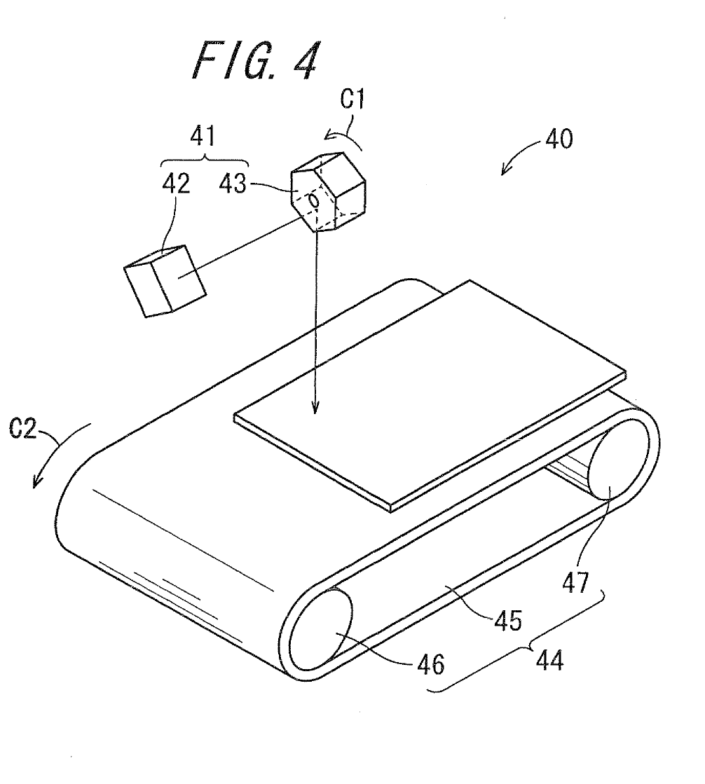

FIG. 4 is a schematic view schematically showing the constitution of the fixing section 40. The fixing section 40 comprises a laser fixing apparatus 41 and a conveying part 44. The laser fixing apparatus 41 comprises a laser light source 42 and a rotary polygon mirror 43. The laser light source 42 is a member emitting laser light, and is constituted such that four kinds of laser lights having different wavelength as oscillation wavelength are separately outputted, respectively. The rotary polygon mirror 43 reflects laser light emitted from the laser light source 42 and exposes a recording medium to laser light with scanning from nearly vertical direction to a toner-bearing face of a recording medium. The rotary polygon mirror 43 has a shape of, for example, regular hexagon, and rotates at constant speed in arrow C1 direction. The laser fixing apparatus 41 can locally emit laser light to a toner image on the recording medium.

The conveying part 44 comprises a conveying belt 45, a driving roller 46 and a driven roller 47. The conveying belt 45 is an endless belt-like member. The conveying belt 45 is supported around the driving roller 46 and the driven roller 47 with tension to form a loop-like passage, and rotates in a direction of arrow C2. The conveying belt 45 may have a constitution that a recording medium is borne on the belt surface by electrostatic force and conveyed, and may have a constitution that a recording medium is borne on the belt surface by wind power and conveyed.

The driving roller 46 is provided such that rotation driving is possible around its axis line by a driving part (not shown). The driving roller 46 rotates the conveying belt 45 to an arrow C2 direction by the rotation driving. The driven roller 47 is rotatably provided so as to be driven with the rotation driving of the driving roller 46, and generates constant tension in the conveying belt 45 such that the conveying belt 45 does not go slack.

Collimator lens, cylinder lens or the like may be provided in an optical path between the laser light source 42 and the rotary polygon mirror 43. Between the rotary polygon mirror 43 and the conveying belt 45, fθ lens, folded mirror, reflective mirror or the like may be provided.

The laser fixing apparatus 41 emits laser light having different wavelength to unfixed toner image held on a recording medium, and can fix the toner to the recording medium in a non-contact state. Specifically, a colorant contained in the unfixed toner on the recording medium absorbs laser light and vibrates, thereby the toner melts by heat and fixes to the recording medium.

The laser light source 42 comprises a Y-fixing laser light source, an M-fixing laser light source, a C-fixing laser light source and a B-fixing laser light source in order to emit laser lights having different four wavelengths. An oscillation wavelength of the Y-fixing laser light source is absorption peak (for example, 430 nm) of a yellow toner in a visible light region. An oscillation wavelength of the M-fixing laser light source is absorption peak (for example, 565 nm) of a magenta toner in a visible light region. An oscillation wavelength of the C-fixing laser light source is absorption peak (for example, 620 nm) of a cyan toner in a visible light region. An oscillation wavelength of the B-fixing laser light source is not particularly limited, and can appropriately be selected from light absorbed by black toner.

Intensity of laser emitted from the laser light source 42 is preferably in a range of from 1.5 W/cm² to 630 W/cm². Where the intensity of laser is lower than 1.5 W/cm², melting of a toner by laser irradiation becomes insufficient, and as a result, fixation rate of a toner is decreased. Where the intensity of laser is larger than 630 W/cm², scorch is generated in a toner or a recording medium by laser irradiation, and this decreases fixation rate of a toner.

According to the fixing section 40, when the recording medium having unfixed toner image borne thereon is conveyed to the conveying part 44 from the transfer nip region, at first laser light from the Y-fixing laser light source is selectively emitted to a yellow toner in the unfixed toner image. At this time, laser light from the Y-fixing laser light source is absorbed by the yellow toner. Thereby, the yellow toner is heated and melted. Next, laser light from the M-fixing laser light source is selectively emitted to a magenta toner in the unfixed toner image. At this time, laser light from the M-fixing laser light source is absorbed by the magenta toner. Thereby, the magenta toner is heated and melted.

Next, laser light from the C-fixing laser light source s selectively emitted to a cyan toner in the unfixed toner image. At this time, laser light from the C-fixing laser light source is absorbed by a cyan toner. Thereby, the cyan toner is heated and melted. Finally, laser from the B-fixing laser light source is selectively emitted to a black toner in the unfixed toner image. At this time, laser light from the B-fixing laser light source is absorbed by the black toner. Thereby, the black toner is heated and melted. Thus, unfixed toner images is all heated and melted. As a result, a toner image is fixed to a recording medium and an image is formed. The recording medium having a toner image fixed thereto is conveyed to a discharging section 60 by the conveying part 44.

The discharging section 60 comprises conveying rollers 61, discharge rollers 62 and a catch tray 63. The conveying rollers 61 are a pair of roller-like members provided so as to come in pressure-contact with each other in the upper part in a vertical direction than the fixing section 40. The conveying rollers 61 convey the recording medium having an image fixed thereto toward the discharge roller 62.

The discharge rollers 62 are a pair of roller-like members provided so as to come in pressure-contact with each other. In the case of one-side printing, the discharge rollers 62 discharge a recording medium having one side printed to the catch tray 63. In the case of double-side printing, the discharge rollers 62 convey a recording medium having one side printed to the registration rollers 54 through a paper conveyance path A3, and discharge the recording medium having both sides printed to the catch tray 63. The catch tray 63 is provided at upper part in a vertical direction of the image forming apparatus 100, and stores recording mediums having an image fixed thereto.

The image forming apparatus 100 includes a control unit section (not shown). The control unit section is provided, for example, upward in a vertical direction in an inner space of the image forming apparatus 100, and comprises a memory part, a calculation part and a control part. Various preset values through an operation panel (not shown) provided in the upper part in a vertical direction of the image forming apparatus 100, detection results from a sensor and the like (not shown) provided in each place inside the image forming apparatus 100, image information from external devices, and the like are inputted in the memory part of the control unit section. Furthermore, programs for performing various processings are written in the memory part. Various processings include a recording medium judgment processing, an attachment amount control processing and a fixing condition control processing.

The memory part can use memories ordinary used in this field, and examples thereof include read-only memory (ROM), random access memory (RAM) and hard disk drive (HDD). The external device can use electric and electronic instruments capable of forming or obtaining image information and capable of electrically connecting to the image forming apparatus 100, and examples thereof include computers, digital cameras, television receivers, video recorders, DVD (Digital Versatile Disc) recorders, HDDVD (High-Definition Digital Versatile Disc) recorders, Blu-ray disc recorders, facsimile apparatuses and mobile terminal devices.

The calculation part retrieves various data (image forming order, detection result, image information and the like) and programs of various processings written in the memory part, and performs various judgments. The control part sends control signal to the appropriate apparatus according to the judgment result of the calculation part, and conducts an operation control.

The control part and the calculation part include a processing circuit implemented by microcomputers, microprocessors or the like equipped with a central processing unit (CPU). The control unit section includes a main power source together with the above-described processing circuit. The power source supplies electric power to not only the control unit, but each member in the image forming apparatus 100.

### Examples

Examples of the invention are specifically described below.

### 1. Measurement Method of Each Physical Property Value

### (1) Absolute Refractive Index n₂ of Binder Resin

The absolute refractive index n₂ of a binder resin was measured with a prism coupling method. Specifically, the absolute refractive index n₂ was measured at a temperature of 20° C. using Abbe refractomer NAR-1T SOLID (manufactured by Atago Co., Ltd.) and using light source lamp: D ray (589 nm).

### (2) Glass Transition Temperature (Tg) of Binder Resin

A DSC curve was measured by heating 1 g of a sample in a temperature rising rate of 10° C./minute according to JIS K7121-1987 using a differential scanning calorimeter (trade name, DSC220, manufactured by Seiko Instruments & Electronics, Ltd.) Temperature of intersection point between a straight line of extending a base line at high temperature side of an endothermic peak corresponding to a glass transition point of the DSC curve obtained to low temperature side and a tangent line drawn at a point that gradient is maximum to a curve of from a rising portion of a peak to the top was obtained as a glass transition temperature (Tg).

### (3) Softening Temperature (Tm) of Binder Resin

In a fluidity characteristic evaluation apparatus (trade name: FLOW TESTER CFT-100C, manufactured by Shimadzu Corporation), a load of 10 kgf/cm² (9.8×10⁵ Pa) was applied to set such that 1 g of a sample is extruded from a die (nozzle bore: 1 mm, length: 1 mm). The sample was heated in a temperature rising rate of 6° C. per minute, and temperature when a half amount of the sample was flown out of the die was obtained. The temperature was used as a softening temperature (Tm).

### (4) Shape Factor SF-2 of Toner Base Particles

A metal film (Au film, film thickness: 0.5 μm) was formed on the surface of the toner base particles by sputter deposition to form metal-coated particles. Using a scanning electron microscope (trade name: S-570, manufactured by Hitachi, Ltd.), 200 to 300 metal-coated particles were randomly extracted from the metal-coated particles obtained above under the conditions of an accelerating voltage of 5 kV and 1,000-fold magnification, and a photo shoot was conducted. The pieces of photograph data were image-analyzed with an image analyzing software (trade name: A-ZO NUN, manufactured by Asahi Kasei Engineering Corporation). Particle analyzing parameters of the image analyzing software (A-ZO KUN) are as follows.

Small graphic removal area: 100 pixels

Contraction separation: Number of times 1

Small graphic: 1

Number of times: 10

Noise removal filer: None

Shading: None

Expression unit of result: 1 μm

Value calculated and obtained from the following expression (B) using a peripheral length PERI and a graphic area (projected area) AREA of the particles obtained by image analysis was used as a shape factor SF-2 of a toner.

Shape factor SF-2={(PERI)²/AREA}×(25/π) (B)

wherein π represents a circular constant.

### (5) Volume Average Particle Size of Toner Base Particles

To 50 ml of electrolyte (trade name: ISOTON-II, manufactured by Beckman Coulter), 20 g of toner base particles and 1 ml of sodium alkyl ether sulfate were added, followed by dispersion treatment at ultrasonic frequency of 20 kHz for 3 minutes by an ultrasonic disperser (trade name: UH-50, manufactured by SMT Co., Ltd.) Thus, a measurement sample was prepared. The measurement sample was measured under the conditions of aperture diameter: 100 μm and the number of particles measured; 50,000 counts using a particle size distribution measuring instrument (trade name: Multisizer III, manufactured by Beckman Coulter), and volume average particle size was obtained from a volume particle size distribution of toner base particles.

### (6) Absolute Refractive Index nₗ of External Additives

The absolute refractive index nₗ of external additives was measured by a prism coupling method. Specifically, the absolute refractive index n₁ was measured at a temperature of 20° C. using Abbe refractomer NAR-1T SOLID (manufactured by Atago Co., Ltd.) and using a light source lamp: D ray (589 nm).

### 2. Examples and Comparative Examples

### (1) Example 1

### (1-1) Preparation of Toner Base Particles

By a mixer (trade name: Henschel Mixer, manufactured by Mitsui Mining Co., Ltd.), 89.0 parts by weight of PMMA (absolute refractive index: 1.49, glass transition temperature: 60° C., softening temperature: 110° C.) as a binder resin, 5.0 parts by weight of a masterbatch (pigment: C.I. Pigment Blue 111, manufactured by DIC Corporation), 4.0 parts by weight of paraffin wax (wax, HNP 11, manufactured by Nippon Seiro Co., Ltd., melting point: 68° C.) and 2.0 parts by weight of alkyl salicylic acid metal salt (charge control agent, trade name: BONTRON E-84, manufactured by Orient Chemical Industries Co., Ltd.) were mixed for 10 minutes, and then melt-kneaded with a twin-screw extruder (trade name: PCM65, manufactured by Ikegai, Ltd.) A toner kneaded material obtained was finely pulverized with a counter jet mill (trade name: Counter Jet Mill AEG, manufactured by Hosokawa Micron Corporation), and then classified with a rotary classifier (trade name: TSP Separator, manufactured by Hosokawa Micron Corporation). Thus, colored resin particles of particles having a volume average particle size of 5.5 μm were prepared. Thereafter, spheronization treatment of the colored resin particles was carried out with a surface reforming machine: METECRAINBOW (trade name, manufactured by Nippon Pneumatic MFG Co., Ltd.) as a hot-air type spheronization apparatus. In the surface reforming machine: METEORRINBOW, the amount of pulverized material (colored resin particles) introduced was 3.0 kg per hour, feed rate of hot air was 900 liters per minute, temperature of hot air was 180° C., supply pressure of cooling air was 0.15 MPa, and feed rate of air from a secondary air injection nozzle was 230 liters per minute. Distance L between cooling air intake and collision member was 2.0 cm. Toner base particles obtained by conducting the spheronization treatment as above had shape factor SF-2 of 115.

The toner base particles and barium carbonate (external additives, absolute refractive index: 1.62, volume average particle size: 30 nm) in an amount of 1.0 part by weight based on 100 parts by weight of the toner base particles were mixed with Henschel mixer. Thus, toner particles having barium carbonate externally added thereto were obtained.

### (1-2) Preparation of Two-Component Developer

The toner obtained and ferrite core carrier having a volume average particle size of 45 μm were mixed for 20 minutes using a V-type mixing machine (trade name: V-5, manufactured by Tokuju Corporation) such that a concentration of the toner in a two-component developer is 7%. Thus, a two-component developer according to Example 1 was prepared. Toner base particles according to Example 1 had a shape factor SF-2 of 115. Absolute refractive index n₁ of the external additives according to Example 1 was 1.62, absolute refractive index n₂ of the binder resin was 1.49, and relative refractive index n₂/n₁ was about 0.92.

### (2) Example 2

A two-component developer according to Example 2 was prepared in the same manner as in Example 1, except that the temperature of hot air was changed to 200° C. in the spheronization treatment of the colored resin particles. Toner base particles according to Example 2 had a shape factor SF-2 of 110. Absolute refractive index n₁ of the external additives according to Example 2 was 1.62, absolute refractive index n₂ of the binder resin was 1.49, and relative refractive index n₂/n₁ was about 0.92.

### (3) Example 3

A two-component developer according to Example 3 was prepared in the same manner as in Example 1, except that the temperature of hot air was changed to 220° C. in the spheronization treatment of the colored resin particles. Toner base particles according to Example 3 had a shape factor SF-2 of 105. Absolute refractive index n₁ of the external additives according to Example 3 was 1.62, absolute refractive index n₂ of the binder resin was 1.49, and relative refractive index n₂/n₁ was about 0.92.

### (4) Example 4

A two-component developer according to Example 4 was prepared in the same manner as in Example 1, except that silica (absolute refractive index: 1.45, volume average particle size: 25 nm) was used in place of barium carbonate as external additives and the temperature of hot air was changed to 200° C. in the spheronization treatment of the colored resin particles. Toner base particles according to Example 4 had a shape factor SF-2 of 110. Absolute refractive index n₁ of the external additives according to Example 4 was 1.45, absolute refractive index n₂ of the binder resin was 1.49, and relative refractive index n₂/n₁ was about 1.03.

### (5) Example 5

A two-component developer according to Example 5 was prepared in the same manner as in Example 1, except that alumina (absolute refractive index: 1.76, volume average particle size: 25 nm) was used in place of barium carbonate as external additives and the temperature of hot air was changed to 200° C. in the spheronization treatment of the colored resin particles. Toner base particles according to Example 5 had a shape factor SE-2 of 110. Absolute refractive index n₁ of the external additives according to Example 5 was 1.76, absolute refractive index n₂ of the binder resin was 1.49, and relative refractive index n₂/n₁ was about 0.85.

### (6) Example 6

A two-component developer according to Example 6 was prepared in the same manner as in Example 1, except that a fluorine-containing polyester resin (fluorine-containing PE, absolute refractive index: 1.52, glass transition temperature: 62° C., softening temperature: 112° C.) was used in place of PMMA as the binder resin and the temperature of hot air was changed to 205° C. in the spheronization treatment of the colored resin particles. Toner base particles according to Example 6 had a shape factor SF-2 of 110. Absolute refractive index of the external additives according to Example 6 was 1.62, absolute refractive index n₂ of the binder resin was 1.52, and relative refractive index n₂/n₁ was about 0.94.

### (7) Example 7

A two-component developer according to Example 7 was prepared in the same manner as in Example 1, except that a fluorine-containing polyester resin (fluorine-containing PE, absolute refractive index: 1.54, glass transition temperature: 61°, softening temperature: 110° C.) was used in place of PMMA as the binder resin, silica (absolute refractive index: 1.45, volume average particle size: 25 nm) was used in place of barium carbonate as external additives and the temperature of hot air was changed to 200° C. in the spheronization treatment of the colored resin particles. Toner base particles according to Example 7 had a shape factor SF-2 of 110. Absolute refractive index n₁ of the external additives according to Example 7 was 1.45, absolute refractive index n₂ of the binder resin was 1.54, and relative refractive index n₂/n₁ was about 1.06.

### (8) Example 8

A two-component developer according to Example 8 was prepared in the same manner as in Example 1, except that silica sand (absolute refractive index: 1.53, volume average particle size: 25 nm) was used in place of barium carbonate as external additives and the temperature of hot air was changed to 200° C. in the spheronization treatment of the colored resin particles. Toner base particles according to Example 8 had a shape factor SF-2 of 110. Absolute refractive index n₁ of the external additives according to Example 8 was 1.53, absolute refractive index n₂ of the binder resin was 1.49, and relative refractive index n₂/n₁ was about 0.97.

### (9) Comparative Example 1

A two-component developer according to Comparative Example 1 was prepared in the same manner as in Example 1, except that the temperature of hot air was changed to 175° C. in the spheronization treatment of the colored resin particles. Toner base particles according to Comparative Example 1 had a shape factor SF-2 of 117. Absolute refractive index n₁ of the external additives according to Comparative Example 1 was 1.62, absolute refractive index n₂ of the binder resin was 1.49, and relative refractive index n₂/n₁ was about 0.92.

### (10) Comparative Example 2

A two-component developer according to Comparative Example 2 was prepared in the same manner as in Example 1, except that a fluorine-containing polyester resin (fluorine-containing PE, absolute refractive index: 1.52, glass transition temperature: 62° C., softening temperature: 112° C.) was used in place of PMMA as the binder resin, silica (absolute refractive index: 1.45, volume average particle size: 25 cm) was used in place of barium carbonate as external additives and the temperature of hot air was changed to 200° C. in the spheronization treatment of the colored resin particles. Toner base particles according to Comparative Example 2 had a shape factor SF-2 of 117. Absolute refractive index n₁ of the external additives according to Comparative Example 2 was 1.45, absolute refractive index n₂ of the binder resin was 1.52, and relative refractive index n₂/n₁ was about 1.05.

### (11) Comparative Example 3

A two-component developer according to Comparative Example 3 was prepared in the same manner as in Example 1, except that a polyester resin (PE, absolute refractive index: 1.57, glass transition temperature: 60° C., softening temperature: 110° C.) was used in place of PMMA as the binder resin, silica (absolute refractive index: 1.45, volume average particle size: 25 nm) was used in place of barium carbonate as external additives and the temperature of hot air was changed to 195° C. in the spheronization treatment of the colored resin particles. Toner base particles according to Comparative Example 3 had a shape factor SF-2 of 117. Absolute refractive index n₁ of the external additives according to Comparative Example 3 was 1.45, absolute refractive index n₂ of the binder resin was 1.57, and relative refractive index n₂/n₁ was about 1.08.

### (12) Comparative Example 4

A two-component developer according to Comparative Example 4 was prepared in the same manner as in Example 1, except that the temperature of hot air was changed to 230° C. in the spheronization treatment of the colored resin particles. Toner base particles according to Comparative Example 4 had a shape factor SF-2 of 102. Absolute refractive index n₁ of the external additives according to Comparative Example 4 was 1.62, absolute refractive index n₂ of the binder resin was 1.49, and relative refractive index n₂/n₁ was about 0.92.

### (13) Comparative Example 5

A two-component developer according to Comparative Example 5 was prepared in the same manner as in Example 1 except that a polyester resin (PE, absolute refractive index: 1.58, glass transition temperature: 62° C., softening temperature: 113° C.) was used in place of PMMA as the binder resin, zinc oxide (absolute refractive index: 1.92, volume average particle size: 30 nm) was used in place of barium carbonate as external additives and the temperature of hot air was changed to 225° C. in the spheronization treatment of the colored resin particles. Toner base particles according to Comparative Example 5 had a shape factor SF-2 of 110. Absolute refractive index n₁ of the external additives according to Comparative Example 5 was 1.92, absolute refractive index n₂ of the binder resin was 1.58, and relative refractive index n₂/n₁ was about 0.82.

### (14) Comparative Example 6

A two-component developer according to Comparative Example 6 was prepared in the same manner as in Example 1, except that titanium oxide (absolute refractive index: 2.52, volume average particle size: 25 nm) was used in place of barium carbonate as external additives and the temperature of hot air was changed to 200° C. in the spheronization treatment of the colored resin particles. Toner base particles according to Comparative Example 6 had a shape factor SE-2 of 110. Absolute refractive index n₁ of the external additives according to Comparative Example 6 was 2.52, absolute refractive index n₂ of the binder resin was 1.49, and relative refractive index n₂/n₁ was about 0.59.

### 3. Evaluation

### (1) Evaluation of Fixability of Toner

Using the two-component developers according to Examples and Comparative Examples, unfixed solid images of 20 cm vertical and 20 cm horizontal were prepared by adjusting such that the toner attachment amount is 1.2 mg/cm² (corresponding to two layers of capsule toner). Using a copying machine in which a fixing device of the commercially available copying machine (trade name: MX-2700, Sharp Corporation) was modified into a fixing device (Y-fixing laser light source: 430 nm, M-fixing laser light source: 565 nm, C-fixing laser light source: 620 nm, B-fixing laser light source: 780 nm, power of each light source: 30 W), the unfixed solid image was irradiated with laser light. In a color fastness rubbing test, a surface of a fixed image was rubbed with an ink eraser (trade name: LION ERASER GAZA SUNA, manufactured by Lion Office Products Corp.) having a load of 1 kg placed herein three reciprocations in a speed of 14 mm/second. Optical reflection density (image density) before and after rubbing was measured using a reflective densitometer (trade name: RD-914, manufactured by MacBeth). Fixing rate was calculated based on the following expression (1), and fixability of a toner was evaluated.

Fixing rate (%)=[(image density after rubbing)/(image density before rubbing)]×100 (1)

Evaluation standard of the fixability is as follows.

Excellent: Very favorable. Fixing rate (%) is 85% or more.

Good: Favorable. Fixing rate (%) is 80% or more and less than 85%.

Fair: No problem in practical use. Fixing rate (%) is 70% or more and less than 80%.

Poor: No good. Fixing rate (%) is less than 70%.

### (2) Evaluation of Cleaning Property

Cleaning property was evaluated as follows. Sharpness of a boundary part between an image area and a non-image area, and presence of absence of black streaks formed by toner leakage in a rotation direction of a photoreceptor drum were visually observed at each of a stage before image formation (Initial), a stage after printing 5,000 (5K) sheets, and a stage after printing 10,000 (10K) sheets.

Evaluation standard of cleaning property is as follows.

Excellent: Favorable. After printing 5K sheets and after printing 10K sheets, a boundary part is sharp, and black streaks are not observed.

Good: After printing 10K sheets, a boundary part is not sharp, and black streaks are not observed.

Fair: After printing 10K sheets, a boundary part is not sharp, and black streaks are observed.

Poor: No good. After printing 5K sheets, a boundary part is not sharp, or black streaks are observed.

### (3) Comprehensive Evaluation

Comprehensive evaluation was made from the evaluation result of fixability of a toner and evaluation result of cleaning property.

Evaluation standard of the comprehensive evaluation is as follows.

Excellent: Very favorable. All evaluations are “Excellent”.

Good: Favorable. One of fixability evaluation and cleaning property evaluation is “Good” or “Fair”, and the other is “Excellent” or “Good”.

Fair: No problem in practical use. Each of fixability evaluation and cleaning property evaluation is “Fair”.

Poor: Evaluation of one or more items is “Poor”.

Kind of binder resin of toner base particles, absolute refractive index n₂, shape factor SF-2, external additives, absolute refractive index n₁, relative absolute refractive index n₂/n₁, and evaluation results of fixability of a toner, cleaning property and comprehensive evaluation are shown in Table 1.

TABLE 1

| | Toner base particles | | | External additives | | | | | | |
|---|---|---|---|---|---|---|---|---|---|---|
| | | Absolute | Shape | | Absolute | Relative | Fixability | | Cleaning | |
| | Kind of | refractive | factor | Kind of external | refractive | refractive | Fixing | | property | Comprehensive |
| | binder resin | index n₂ | SF-2 | additives | index n₁ | index n₂/n₁ | rate | Evaluation | evaluation | evaluation |
| Example 1 | PMMA | 1.49 | 115 | Barium | 1.62 | 0.920 | 86% | Excellent | Excellent | Excellent |
| | | | | carbonate | | | | | | |
| Example 2 | PMMA | 1.49 | 110 | Barium | 1.62 | 0.920 | 88% | Excellent | Excellent | Excellent |
| | | | | carbonate | | | | | | |
| Example 3 | PMMA | 1.49 | 105 | Barium | 1.62 | 0.920 | 90% | Excellent | Excellent | Excellent |
| | | | | carbonate | | | | | | |
| Example 4 | PMMA | 1.49 | 110 | Silica | 1.45 | 1.03 | 83% | Good | Excellent | Good |
| Example 5 | PMMA | 1.49 | 110 | Alumina | 1.76 | 0.847 | 87% | Excellent | Excellent | Excellent |
| Example 6 | Fluorine- | 1.52 | 110 | Barium | 1.62 | 0.938 | 79% | Fair | Excellent | Good |
| | containing PE | | | carbonate | | | | | | |
| Example 7 | Fluorine- | 1.54 | 110 | Silica | 1.45 | 1.06 | 81% | Good | Excellent | Good |
| | containing PE | | | | | | | | | |
| Example 8 | PMMA | 1.49 | 110 | Silica sand | 1.53 | 0.974 | 94% | Excellent | Excellent | Excellent |
| Comparative | PMMA | 1.49 | 117 | Barium | 1.62 | 0.920 | 68% | Poor | Excellent | Poor |
| Example 1 | | | | carbonate | | | | | | |
| Comparative | Fluorine- | 1.52 | 117 | Silica | 1.45 | 1.05 | 68% | Poor | Excellent | Poor |
| Example 2 | containing PE | | | | | | | | | |
| Comparative | PE | 1.57 | 117 | Silica | 1.45 | 1.08 | 63% | Poor | Excellent | Poor |
| Example 3 | | | | | | | | | | |
| Comparative | PMMA | 1.49 | 102 | Barium | 1.62 | 0.920 | 94% | Excellent | Poor | Poor |
| Example 4 | | | | carbonate | | | | | | |
| Comparative | PE | 1.58 | 110 | Zinc oxide | 1.92 | 0.823 | 64% | Poor | Excellent | Poor |
| Example 5 | | | | | | | | | | |
| Comparative | PMMA | 1.49 | 110 | Titanium | 2.52 | 0.591 | 60% | Poor | Excellent | Poor |
| Example 6 | | | | oxide | | | | | | |

It is seen from Table 1 that when the shape factor SF-2 is 115 or less and the relative refractive index n₂/n₁ is from 0.85 to 1.10, fixability is high. It is further seen that when the shape factor SF-2 is 105 or more, cleaning property is high.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An infrared absorber-free light fixing toner for use in a fixing method of fixing a toner to a recording medium by irradiation of light having a wavelength within an absorption wavelength region of a colorant, comprising:
toner base particles comprising a binder resin and a colorant, the toner base particles having a shape factor SF-2 of from 105 to 115; and
external additives externally added to the toner base particles,
a relative refractive index n₂/n₁ as a ratio between an absolute refractive index nₗ of the external additives and an absolute refractive index n₂ of the binder resin being from 0.85 to 1.10.

2. The light fixing toner of claim 1, wherein the toner is a cyan toner, a magenta toner or a yellow toner.

3. The light fixing toner of claim 1, wherein the binder resin has an absolute refractive index n₂ of 1.5 or less.

4. A one-component developer comprising the light fixing toner of claim 1.

5. A two-component developer comprising the light fixing toner of claim 1 and a carrier.
